(19) United States
(12) Patent Application Publication
(10) Pub. No.: US 2016/0320926 A1
(43) Pub. Date: Nov. 3, 2016

(54) E-MAIL INTERFACE AND METHOD FOR PROCESSING USER INTERACTIONS WITH EMAIL MESSAGES

(71) Applicant: Yandex Europe AG, Luzern (CH)

(72) Inventors: Egor Vladimirovitch GANIN, Shishkin Les, Moscow region (RU); Bogdan Yurievich GARKUSHIN, Krasnogorsk, Moscow region (RU); Vasily Aleksandrovich SHMELEV, Kolomna, Moscow region (RU)

(21) Appl. No.: 15/107,476

(22) PCT Filed: Nov. 24, 2014
(86) PCT No.: PCT/IB2014/066296

§ 371 Date: Jun. 23, 2016

(30) Foreign Application Priority Data
May 22, 2014 (RU) 2014120701

(51) Int. Cl. G06F 3/0482; G06F 3/0484; H04L 12/58; G06F 3/0488

(52) U.S. Cl. CPC G06F 3/0482; G06F 3/04883; G06F 3/04886; G06F 3/04842; H04L 51/36

(57) ABSTRACT

There is disclosed a method for displaying an e-mail message to an e-mail message recipient using an electronic device, the electronic device having a touch-sensitive screen. The method is executable at the electronic device. The method comprises: displaying on the touch-sensitive screen an indication of the e-mail message; appreciating a category of the e-mail message; based on the category of the e-mail message, appreciating an indication of a past behaviour pattern associated with the e-mail recipient; receiving an indication of a user-interaction with the touch-screen display in association with the e-mail message; displaying to the e-mail message recipient on the touch-sensitive screen an indication of an action to be executed with the e-mail message, the action based on the past behaviour pattern.

### CROSS-REFERENCE

The present application claims convention priority to Russian Patent Application No. 2014120701, filed May 22, 2014, entitled “E-MAIL INTERFACE AND METHOD FOR PROCESSING USER INTERACTIONS WITH EMAIL MESSAGES” which is incorporated by reference herein in its entirety.

### FIELD

The present technology relates to webmail and, specifically, to an e-mail interface and method for processing user interactions with email messages.

### BACKGROUND

Electronic mail messages, usually shortened as ‘email’ or ‘e-mail’ or “email-message”, have become a very common means of communication. Indeed, in many situations, e-mail messaging has replaced the standard post letter, the telephone and the facsimile as the preferred means of communication. This has lead to increases in the volume of e-mail messages being sent and received; so much so that in many cases people find it difficult to manage their e-mail messages leading to the undesirable situation that some e-mail messages may not be timely dealt with or may not be dealt with at all.

With the recent developments in computer and telecommunication technologies, a typical user has a plethora of choices available to her as to which electronic device to use to check her e-mail messages. For example, a given user may have access to a desktop computer at her work. The given user may also have a personal laptop at home. Finally, the given user may also have a wireless communication device (such as a smart phone or a tablet) at her disposition. As such, the given user may use any one of these available devices (the desktop, the laptop and the wireless communication device) to check her e-mails.

As one will appreciate, each one of these available devices (the desktop, the laptop and the wireless communication device) is associated with its respective user interface for displaying information to the user and/or for receiving information from the user. The user interface can be mono-utilitarian in nature (such as a screen for displaying information to the user and a key board for user entering information) or multi-utilitarian in nature (such as a touch screen for both displaying information to the user and allowing the user to enter information). Irrespective of the nature of the user interface, each of these devices would have the user interface for displaying information to the user of a different size. For example, a typical desktop computer has a screen that is larger than that of a typical laptop. By the same token, the typical laptop has a screen that is larger that the touchscreen of a typical tablet or, even more so, of a typical smart phone.

In order to access and check the e-mails, a typical user has two primary choices. On the one hand, the typical user can run an e-mail application on the electronic device to check and/or compose e-mail messages. One of the examples of such an e-mail application would be Outlook™ e-mail client from Microsoft Corporation Redmond, Wash., United States of America. With such a typical e-mail application, the user would need to provision (i.e. download, install and set up) such the e-mail application on every electronic device the user is desirous of using to check her e-mail messages.

On the other hand, the user may use a webmail interface client to check her e-mail messages. Within this scenario, the user may log into the webmail interface provided by the vendor of the e-mail services. For example, the user of the Yandex.Mail service may access the webmail interface by going to mail.yandex.com and log into the webmail service by providing username and credential combination. The user is then taken to the main page of the webmail interface, where the user can check e-mail, compose e-mail, organize the inbox and the like. Unlike the scenario with the e-mail application that needs to be locally installed, the user can access the webmail interface using virtually any electronic device that has Internet connection.

Referring to FIG. 2, there is shown a partial screen shot 200 of a user's inbox of the Yandex™ webmail e-mail service, implemented generally in accordance with known techniques. The screen shot 200 generally depicts what is known as a home screen or an inbox view of the webmail e-mail service. In the inbox there is an e-mail message listing in which information about e-mail messages having been received is shown. Information about a message 202 is shown in a conventional format using information extracted from that e-mail message's header. Thus there is shown a name 204 of the sender of e-mail message 202 (from the e-mail's From header field), a subject 206 of the e-mail message 202 (from the e-mail's Subject header field), a time 208 of e-mail message 202 (from the e-mail's Date header field).

A message 210 however is shown in accordance to another prior art technique. The information abut the message 210 is extracted from the content of the body of the message 210 (via use of regular expressions, etc.) and has been presented in the e-mail message listing in a standardized format appropriate for the type of the message 210. The following information regarding message 210 is displayed in the e-mail message listing: an outbound flight number 212 (Flight No. NN-658); a departure city, date, and time 214 (Moscow, August 20, 11:20 pm); a return flight number 216 (Flight No, NN-658); a return city, date, and time 218 (Amsterdam, August 24, 7:40 pm). In this example, information has also been extracted from an external internet resource (i.e. the airline KLM's website) in the form of an airline KLM's logo 220 and has been presented in the message 210 listing. The KLM logo 220 is also a widget in that clicking on the logo by the user will take the user to the airline KLM's website in the user's web browser. The time 224 of the e-mail message 210 (from the e-mail's Date header field) is also displayed, along with a print 222 functionality.

The screen shot 200 also shows a number of inbox commands 240, which in this example include: “New Message”, “Refresh” and the like.

Once the user selects a particular message within the inbox and irrespective of which mode of checking for e-mail messages the user uses (local e-mail application or the webmail interface), both provide the user with a number of action buttons to enable the user to take one or more action with her e-mail. These action buttons include well known action buttons, such as “new”, “delete”, “reply”, “reply all”, “forward”, “move”, “mark unread”, “categorize”, “address book” and many others.

Referring to FIG. 3, there is shown a partial screen shot 300 of a user's e-mail message reading pane of the Yandex webmail e-mail service, the reading pane implemented in accordance to known techniques. It should be noted that in this illustration the user enters into the reading pane of FIG. 3 by means of clicking (or otherwise selecting) the message 210 of FIG. 1.

In FIG. 3, the user is viewing the actual e-mail message 210 a preview of which is shown in FIG. 2. The viewing pane shows an e-mail's header information 302 and the body 304 of the e-mail. The email body has also been reformatted with certain information that has been extracted from the body 304 of the e-mail and is displayed at the top of the viewing pane in a standardized format (according to this message's message type “ticket”). In this respect, at the top of the viewing pane there is displayed the following information: an outbound flight number 308 (Flight No. NN-658); a departure city, date, and time 310 (Moscow, August 20, 11:20 pm); a return flight number 312 (Flight No, NN-658); a return city, date, and a time 314 (Amsterdam, August 24, 7:40 pm). A widget 316 allowing the user to be reminded of this information (i.e. the flight information) at the appropriate times has been added, as well as printer functionality 318.

The viewing pane also has a plurality of message action buttons 340. Within the depicted illustration, the plurality of message action buttons 340 includes inter alia (all not separately numbered): “new message”, “refresh”, “reply”, “forward”, “delete”, “move to spam”, “mark unread”, “category” and “move to folder” buttons. All of these action buttons (i.e. the plurality of message action buttons 340) are meant to enable the user to perform various actions with her e-mail messages. In the never-ending strive to make users' experience more “user friendly”, providers of such e-mail applications and webmail interfaces have added more and more action buttons to enable the user to quickly navigate to the desired action and execute such an action.

Needless to say, all these action buttons require real estate of the screen to be displayed to the user. Combined with other control panels of the e-mail applications or webmail interfaces (inbox tree panel, folder tree panel, preview pane and the like), this can be demanding on the real estate of the screen. Whereas it may not be such a big issue with desktops or larger laptops (which would have screen shots similar to those shown in FIG. 2 and FIG. 3), with the tablets and smart phones, the relatively small screen may lead to the user perceiving the experience of using the prior art e-mail application or the webmail interface as not entirely satisfactory.

US 2010/0153325 teaches a message processing system and a method that recommends actions for incoming messages based upon past historical e-mail behavior information. The historical e-mail behavior information represents a user's behavior for a plurality of past messages and an action is recommended based on a comparison of the incoming messages to the historical e-mail behavior information.

US 2012/0290662 discloses automatically learning user behavioral patterns when interacting with messages and based on the learned patterns, suggesting one or more predicted actions that a user might take in response to receiving subsequent message. One or more classifiers are trained and employed to predict one or more actions that a user might take in response to receiving the message. In one embodiment, the one or more predicted actions are provided suggested to the user as an action the user might take on the message. Messages may be rank ordered within a given suggested action based on a confidence level of the prediction.

U.S. Pat. No. 8,611,866 teaches a system and method for providing a plurality of options to a mobile telephone user based upon the user's prior activities. The present invention includes an “action input,” the actuation of which results in a menu of previously performed activities by the user. For example, the menu can display activities that frequently occur at the same time each day. The device software can automatically update and arrange the respective options based upon the user's activities.

U.S. Pat. No. 8,542,206 discloses systems, methods, and devices for interpreting manual swipe gestures as input in connection with touch-sensitive user interfaces that include virtual keyboards are disclosed herein. These allow for a user entering text using the virtual keyboard to perform certain functions using swipes across the key area rather than tapping particular keys. For example, leftward, rightward, upward, and downward swipes can be assigned to inserting a space, backspacing, shifting (as for typing capital letters), and inserting a carriage return and/or new line. Various other mappings are also described. The described techniques can be used in conjunction with a variety of devices, including handheld devices that include touch-screen interfaces, such as desktop computers, tablet computers, notebook computers, handheld computers, personal digital assistants, media players, mobile telephones, and combinations thereof.

U.S. Pat. No. 7,614,008 teaches a touch screen computer that executes an application. A method of operating the touch screen computer in response to a user is provided. A virtual input device is provided on the touch screen. The virtual input device comprises a plurality of virtual keys. It is detected that a user has touched the touch screen to nominally activate at least one virtual key, and a behavior of the user with respect to touch is determined. The determined behavior is processed and a predetermined characteristic is associated with the nominally-activated at least one virtual key. A reaction to the nominal activation is determined based at least in part on a result of processing the determined behavior.

### SUMMARY

It is an object of the present technology to ameliorate at least some of the inconveniences present in the prior art.

According to a first broad aspect of the present technology, there is provided a method for displaying an e-mail message on a webmail page. The method is executable at a webmail server. The method comprises: receiving, via a communication network, from an electronic device associated with an e-mail recipient, a request for pending e-mail messages for the e-mail recipient; retrieving from an e-mail database, a pending e-mail message having a destination address designating the e-mail recipient; determining a category of the pending e-mail message; based on the category of the pending e-mail message, retrieving from a behaviour database an indication of a past behaviour pattern associated with the e-mail recipient; sending to the electronic device, via the communication network, a trigger, the trigger being instrumental in causing the electronic device to display the webmail page, the webmail page showing: the pending e-mail message; and a first command button and a second command button in an order, the order of the first command button and the second command button having been selected based on the past behaviour pattern.

In some implementations of the method, the method further comprises selecting the first command button and the second command button from a plurality of command buttons based on the past behaviour pattern.

In some implementations of the method, the first command button and the second command button are the only command buttons displayed.

In some implementations of the method, the trigger is being further instrumental in causing the electronic device to display a third command button, the third command button also organized in the order with the first command button and the second command button, the first command button, the second command button and the third command button having been selected from a plurality of command buttons based on the past behaviour pattern.

In some implementations of the method, the first command button, the second command button and the third command button are the only command buttons displayed.

In some implementations of the method, the method further comprises, prior to the receiving: storing in the behaviour database the indication of the past behaviour pattern associated with the e-mail recipient, the past behaviour pattern based on the actions taken by the e-mail message recipient with at least one past e-mail message belonging to the category.

In some implementations of the method, the step of storing comprises storing the past behaviour pattern in association with a user profile of the e-mail recipient.

In some implementations of the method, the past behaviour pattern is indicative of the most likely action to be taken by the e-mail message recipient in association with the pending e-mail message.

In some implementations of the method, the first command button is associated with the most likely action and the order comprises placing the first command button first.

In some implementations of the method, the past behaviour pattern is indicative of a second most likely action to be taken by the e-mail message recipient in association with the pending e-mail message.

In some implementations of the method, the second command button is associated with the second most likely action and the order comprises placing the second command button after the first command button.

In some implementations of the method, the step of placing second command button after the first command button comprises one of: placing the second command button to the right of the first command button; placing the second command button to the left of the first command button; placing the second command button to the top of the first command button; placing the second command button to the bottom of the first command button.

In some implementations of the method, the actions taken by the e-mail message recipient with at least one past e-mail message belonging to the category comprising a first past action taken by the e-mail message recipient with a first past e-mail message and a second past action taken by the e-mail message recipient with a second past e-mail message, both the first past e-mail message and the second past e-mail message belonging to the category, the method further comprising, prior to the storing, determining the past behaviour pattern based on the first past action and the second past action.

In some implementations of the method, the step of determining is executed using machine learning algorithms.

In some implementations of the method, the trigger is being instrumental in causing the electronic device to display the webmail page in a webmail interface of the electronic device.

In some implementations of the method, the step of receiving the request for pending e-mail messages for the e-mail message recipient is executed in response to the e-mail message recipient interacting with the webmail interface.

In some implementations of the method, the interacting comprises authenticating in the webmail interface using user credentials.

In some implementations of the method, the step retrieving the pending e-mail message and the step of retrieving the indication of a past behaviour pattern are executed at least partially based on user credentials.

In some implementations of the method, the step of determining the category of the pending e-mail message comprises selecting the category from a plurality of pre-set categories based on at least one of a sender of the pending e-mail message and application of a categorization rule.

According to another broad aspect of the present technology, there is provided a method for displaying an e-mail message on a webmail page. The method is executable at a webmail server. The method comprises: receiving, via a communication network, from an electronic device associated with an e-mail recipient, a request for pending e-mail messages for the e-mail recipient; retrieving from an e-mail database, a pending e-mail message having a destination address designating the e-mail recipient; determining a category of the pending e-mail message; based on the category of the pending e-mail message, retrieving from a behaviour database an indication of a past behaviour pattern associated with the e-mail recipient; sending to the electronic device, via the communication network, a trigger, the trigger being instrumental in causing the electronic device to display the webmail page, the webmail page showing: the pending e-mail message; and a command button, the command button having been selected based on the past behaviour pattern, the command button for indicating user desire to perform an action with the e-mail message displayed on the webmail page.

In some implementations of the method, the command button is the only command button for indicating user desire to perform an action with the e-mail message displayed on the webmail page.

According to another broad aspect of the present technology, there is provided a server. The server comprises: a communication interface for communication with an electronic device via a communication network; a processor operationally connected with the communication interface, the processor configured to: receive, via the communication interface, from the electronic device associated with an e-mail recipient, a request for pending e-mail messages for the e-mail recipient; retrieve from an e-mail database, a pending e-mail message having a destination address designating the e-mail recipient; determine a category of the pending e-mail message; based on the category of the pending e-mail message, retrieve from a behaviour database an indication of a past behaviour pattern associated with the e-mail recipient; send, via the communication interface, to the electronic device, via the communication network, a trigger, the trigger being instrumental in causing the electronic device to display the webmail page, the webmail page showing: the pending e-mail message; and a first command button and a second command button in an order, the order of the first command button and the second command button having been selected based on the past behaviour pattern.

In some implementations of the server, the processor is being further operable to select the first command button and the second command button from a plurality of command buttons based on the past behaviour pattern.

In some implementations of the server, the first command button and the second command button are the only command buttons displayed.

In some implementations of the server, the trigger is being further instrumental in causing the electronic device to display a third command button, the third command button also organized in the order with the first command button and the second command button, the first command button, the second command button and the third command button having been selected from a plurality of command buttons based on the past behaviour pattern.

In some implementations of the server, the first command button, the second command button and the third command button are the only command buttons displayed.

In some implementations of the server, the processor is being further operable, prior to the receiving, to: store in the behaviour database the indication of the past behaviour pattern associated with the e-mail recipient, the past behaviour pattern based on the actions taken by the e-mail message recipient with at least one past e-mail message belonging to the category.

In some implementations of the server, to store, the processor is operable to store the past behaviour pattern in association with a user profile of the e-mail recipient.

In some implementations of the server, the past behaviour pattern is indicative of the most likely action to be taken by the e-mail message recipient in association with the pending e-mail message.

In some implementations of the server, the first command button is associated with the most likely action and the order comprises placing the first command button first.

In some implementations of the server, the past behaviour pattern is indicative of a second most likely action to be taken by the e-mail message recipient in association with the pending e-mail message.

In some implementations of the server, the second command button is associated with the second most likely action and the order comprises placing the second command button after the first command button.

In some implementations of the server, to place the second command button after the first command button, the processor is operable for: placing the second command button to the right of the first command button; placing the second command button to the left of the first command button; placing the second command button to the top of the first command button; placing the second command button to the bottom of the first command button.

In some implementations of the server, the actions taken by the e-mail message recipient with at least one past e-mail message belonging to the category comprising a first past action taken by the e-mail message recipient with a first past e-mail message and a second past action taken by the e-mail message recipient with a second past e-mail message, both the first past e-mail message and the second past e-mail message belonging to the category, the processor being further operable, prior to the storing, to determine the past behaviour pattern based on the first past action and the second past action.

In some implementations of the server, to determine the past behaviour pattern, the processor is operable to execute a machine learning algorithm.

In some implementations of the server, the trigger is being instrumental in causing the electronic device to display the webmail page in a webmail interface of the electronic device.

In some implementations of the server, the processor receives the request for pending e-mail messages for the e-mail message recipient in response to the e-mail message recipient interacting with the webmail interface.

In some implementations of the server, the interacting comprises authenticating in the webmail interface using user credentials.

In some implementations of the server, to retrieve the pending e-mail message and to retrieve the indication of a past behaviour pattern, the processor is configured to use, at least partially, user credentials.

In some implementations of the server, to determine the category of the pending e-mail message, the processor is configured to select the category from a plurality of pre-set categories based on at least one of a sender of the pending e-mail message and application of a categorization rule.

According to another broad aspect of the present technology, there is provided a method for displaying an e-mail message to an e-mail message recipient using an electronic device, the electronic device having a touch-sensitive screen. The method is executable at the electronic device. The method comprises: displaying on the touch-sensitive screen an indication of the e-mail message; appreciating a category of the e-mail message; based on the category of the e-mail message, appreciating an indication of a past behaviour pattern associated with the e-mail recipient; receiving an indication of a user-interaction with the touch-screen display in association with the e-mail message; displaying to the e-mail message recipient on the touch-sensitive screen an indication of an action to be executed with the e-mail message, the action based on the past behaviour pattern.

In some implementations of the method, the past behaviour pattern is indicative of the most likely action the e-mail message recipient is to execute with the e-mail message based on e-mail message recipient actions with prior e-mail message of the same category.

In some implementations of the method, the indication of the action comprises the most likely action.

In some implementations of the method, the method further comprises determining the action by selection the action from a plurality of pre-set actions based on the past behavior pattern.

In some implementations of the method, the user-interaction with the touch-screen display comprises one of: a tap; a single finger swipe; a double finger swipe; a virtual button actuation; a physical button actuation.

In some implementations of the method, the step of displaying to the e-mail message recipient on the touch-sensitive screen an indication of an action to be executed with the e-mail message comprises displaying a first indication of a first action and an indication of a second action in an order.

In some implementations of the method, both the first action and the second action are based on the past behaviour pattern.

In some implementations of the method, the order is based on the past behaviour pattern.

In some implementations of the method, all of the first action, the second action and the order are based on the past behaviour pattern.

In some implementations of the method, the step of appreciating the category of the e-mail message comprises determining the category of the e-mail message at the electronic device.

In some implementations of the method, the step of appreciating the category of the e-mail message comprises receiving an indication of the category of the e-mail message from an e-mail server.

In some implementations of the method, the step of appreciating the indication of the past behaviour pattern comprises retrieving the indication of the past behaviour pattern from a local memory.

In some implementations of the method, the step of appreciating the indication of the past behaviour pattern comprises receiving the indication of the past behaviour pattern from an e-mail server.

In some implementations of the method, the method further comprises executing the action with the e-mail message.

In some implementations of the method, the step of executing is executed in response to receiving a positive confirmation from the e-mail recipient.

In some implementations of the method, the method further comprises not executing the action in response to receiving a negative confirmation from the e-mail recipient.

In some implementations of the method, the method further comprises updating the past behaviour pattern based on one of positive confirmation and the negative confirmation from the e-mail recipient.

In some implementations of the method, the step of receiving the positive confirmation is executed in response to the e-mail message recipient executing an action with the indication of the action.

In some implementations of the method, the action comprises one of: tapping; double tapping; swiping.

In some implementations of the method, the step of appreciating the category of the e-mail message comprises selecting the category from a plurality of pre-set categories based on at least one of a sender of the e-mail message and application of a categorization rule.

In accordance with another broad aspect of the present technology, there is provided an electronic device. The electronic device comprises: a touch-sensitive screen for receiving a user input and providing a user output; a network communication interface for two-way communication over a communication network; and a processor coupled to the touch-sensitive screen and the network communication interface, the processor being configured to have access to computer readable commands which commands, when executed, cause the processor to execute an e-mail application, the commands being further operable to cause the processor to: display on the touch-sensitive screen an indication of the e-mail message; appreciate a category of the e-mail message; based on the category of the e-mail message, appreciate an indication of a past behaviour pattern associated with the e-mail recipient; receive an indication of a user-interaction with the touch-screen display in association with the e-mail message; display to the e-mail message recipient on the touch-sensitive screen an indication of an action to be executed with the e-mail message, the action based on the past behaviour pattern.

In some implementations of the electronic device, the past behaviour pattern is indicative of the most likely action the e-mail message recipient is to execute with the e-mail message based on e-mail message recipient actions with prior e-mail message of the same category.

In some implementations of the electronic device, the indication of the action comprises the most likely action.

In some implementations of the electronic device, the commands are being further operable to cause the processor to determine the action by selection the action from a plurality of pre-set actions based on the past behavior pattern.

In some implementations of the electronic device, the user-interaction with the touch-screen display comprises one of: a tap; a single finger swipe; a double finger swipe; a virtual button actuation; a physical button actuation.

In some implementations of the electronic device, to cause the processor to cause displaying to the e-mail message recipient on the touch-sensitive screen an indication of an action to be executed with the e-mail message, the commands are operable to cause the processor to display on the touch-sensitive screen a first indication of a first action and an indication of a second action in an order.

In some implementations of the electronic device, both the first action and the second action are based on the past behaviour pattern.

In some implementations of the electronic device, the order is based on the past behaviour pattern.

In some implementations of the electronic device, all of the first action, the second action and the order are based on the past behaviour pattern.

In some implementations of the electronic device, to cause the processor to appreciate the category of the e-mail message, the commands are operable to cause the processor to determine the category of the e-mail message at the electronic device.

In some implementations of the electronic device, to cause the processor to appreciate the category of the e-mail message, the commands are operable to cause the processor to receive an indication of the category of the e-mail message from an e-mail server.

In some implementations of the electronic device, to cause the processor to appreciate the category of the e-mail message, the commands are operable to cause the processor to retrieve the indication of the past behaviour pattern from a local memory.

In some implementations of the electronic device, to appreciate the indication of the past behaviour pattern, the commands are operable to cause the processor to receive the indication of the past behaviour pattern from an e-mail server.

In some implementations of the electronic device, the commands are further operable to cause the processor to execute the action with the e-mail message.

In some implementations of the electronic device, the commands are being operable to cause the processor to execute the action in response to receiving a positive confirmation from the e-mail recipient.

In some implementations of the electronic device, the commands are being further operable to cause the processor to not execute the action in response to receiving a negative confirmation from the e-mail recipient.

In some implementations of the electronic device, the commands are being further operable to cause the processor to update the past behaviour pattern based on one of positive confirmation and the negative confirmation from the e-mail recipient.

In some implementations of the electronic device, the commands are configured to cause the processor to receive the positive confirmation in response to the e-mail message recipient executing an action with the indication of the action.

In some implementations of the electronic device, the action comprises one of: tapping; double tapping; swiping.

In some implementations of the electronic device, to cause the processor to appreciate the category of the e-mail message, the commands are configured to cause the processor to select the category from a plurality of pre-set categories based on at least one of a sender of the e-mail message and application of a categorization rule.

According to another broad aspect of the present technology, there is provided a method for displaying an electronic message to an electronic message recipient using an electronic device. The electronic device has a touch-sensitive screen. The method is executable at the electronic device. The method comprises: displaying on the touch-sensitive screen an indication of the electronic message; appreciating a category of the electronic message; based on the category of the electronic message, appreciating an indication of a past behaviour pattern associated with the electronic message recipient; receiving an indication of a user-interaction with the touch-screen display in association with the electronic message; displaying to the electronic message recipient on the touch-sensitive screen an indication of an action to be executed with the electronic message, the action based on the past behaviour pattern.

In the context of the present specification, a “server” is a computer program that is running on appropriate hardware and is capable of receiving requests (e.g. from client devices such as communication devices associated with e-mail receivers) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” and “communication device” are synonymous and designate any electronic device or computer hardware that is capable of running software appropriate to the relevant task at hand and is capable further of communicating with a server, either directly or through a network, by means of a wired connection including without limitation a cable or optical fiber connection, or by means of a wireless connection including without limitation a cellular, WiFi or Bluetooth™ connection. Thus, some (non-limiting) examples of client devices or communication devices include personal computers (desktops, laptops, netbooks, etc.), and mobile devices such as smartphones and tablets, as well as network equipment such as routers, switches, and gateways. It should be noted that a device acting as a client device or communication device in the present context is not precluded from acting as a server to other client devices or communication devices. The use of the expressions “a client device” and “a communication device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer information storage medium” is intended to include media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage medium, including two or more media components of a same type and/or two or more media components of different types.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram illustrating a system 100, the system 100 being implemented in accordance with embodiments of the present technology.

FIG. 2 is a partial screen shot of a user's inbox of the Yandex™ webmail e-mail service, the user's inbox implemented in accordance with known techniques.

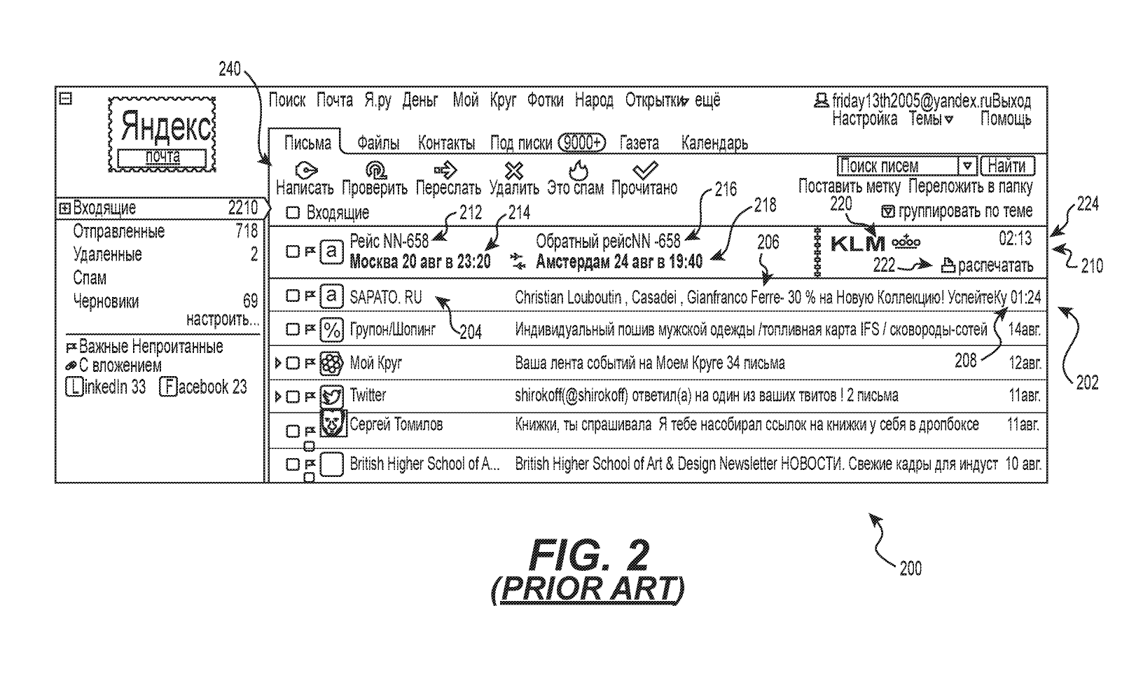

FIG. 3 is a partial screen shot of a user's e-mail message reading pane of the Yandex webmail e-mail service, the user's inbox implemented in accordance with known techniques.

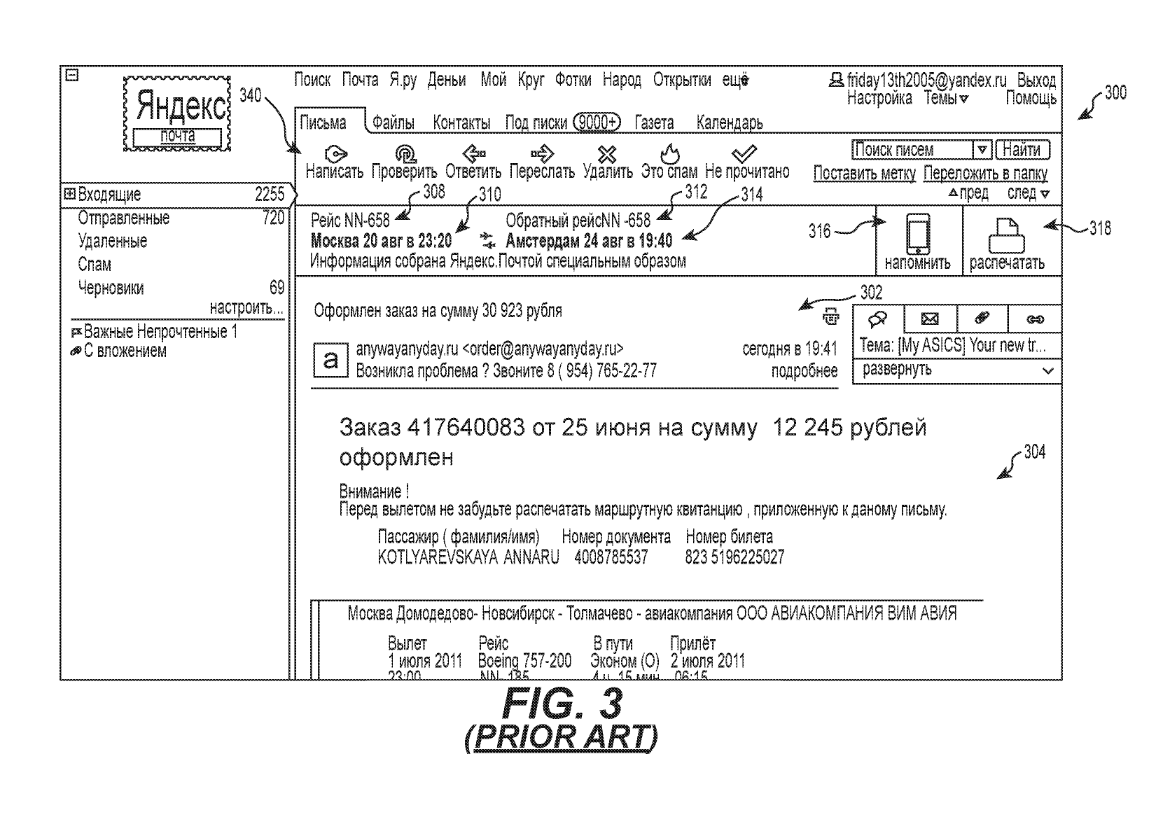

FIG. 4 depicts a block diagram showing steps of a method 400, the method 400 being executable within the system 100 of FIG. 1, the method 400 being executed according to non-limiting embodiments of the present technology.

FIG. 5 depicts a block diagram showing steps of a method 500, the method 500 being executable within the system 100 of FIG. 1, the method 500 being executed according to non-limiting embodiments of the present technology.

FIG. 6 depicts a screen shot 600, the screen shot 600 illustrating the e-mail application 104 executed within the system 100 of FIG. 1, the e-mail application 104 being implemented according to a non-limiting embodiment of the present technology.

FIG. 7 depicts a screen shot 700, the screen shot 700 illustrating the e-mail application 104 executed within the system 100, the e-mail application 104 being implemented according to a non-limiting embodiment of the present technology and being in the “inbox view” mode.

FIG. 8 depicts a screen shot 800, the screen shot 800 illustrating the e-mail application 104 executed within the system 100 of FIG. 1, the e-mail application 104 being implemented according to a non-limiting embodiment of the present technology.

FIG. 9 depicts a screen shot 900, the screen shot 900 illustrating an embodiment of a chat application 904 executed within the system 100 of FIG. 1, the chat application 904 being implemented according to a non-limiting embodiment of the present technology.

### DETAILED DESCRIPTION

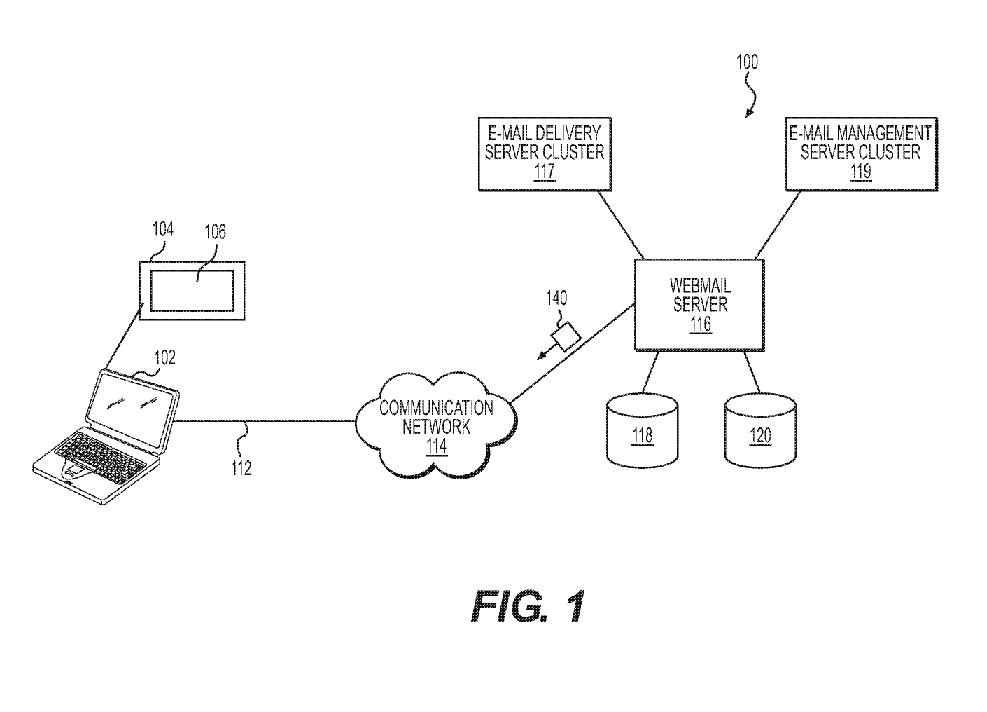

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered or the like.

The implementation of the electronic device 102 is not particularly limited, but as an example, the electronic device 102 may be implemented as a personal computer (desktops, laptops, netbooks, etc.), a wireless electronic device (a cell phone, a smartphone, a tablet and the like), as well as network equipment (a router, a switch, or a gateway). The general implementation of the electronic device 102 is known in the art and, as such, will not be described here at much length. Suffice it to say that the electronic device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over a communication network 114; and a processor coupled to the user input interface, the user output interface and the network communication interface, the processor being configured to execute various routines, including those described herein below. To that end the processor may store or have access to computer readable commands which commands, when executed, cause the processor to execute the various routines described herein.

The electronic device 102 comprises hardware and/or software and/or firmware (or a combination thereof), as is known in the art, to execute an e-mail application 104. Generally speaking, the purpose of the e-mail application 104 is to enable the user (not depicted) to: browse a list of e-mails (both unread and read), read specific e-mail messages, open attachments, compose new e-mail messages, reply to e-mail messages, forward e-mail messages, delete e-mail messages, manage junk e-mail messages, assign categories to e-mail messages, organize e-mail messages into folders, create and access an address book and the like.

In some embodiments, the e-mail application 104 can be implemented as a webmail interface. In other embodiments, the e-mail application 104 can be implemented as an e-mail application, for example, an e-mail application executed on the electronic device 102 being a smartphone. Irrespective of how the e-mail application 104 is implemented, the e-mail application provides the user with an e-mail interface 106. The e-mail interface 106 is configured, as in known in the art, to allow the user to indicate interact with the e-mail application 104 in order to: browse a list of e-mails (both unread and read), read specific e-mail messages, open attachments, compose new e-mail messages, reply to e-mail messages, forward e-mail messages, delete e-mail messages, manage junk e-mail messages, assign categories to e-mail messages, organize e-mail messages into folders, create and access an address book and the like. The list of example actions that the user is able to execute with the e-mail interface 106 is not exhaustive and may include a number of additional or different examples.

The electronic device 102 is coupled to the above-mentioned communication network 114 via a communication link 112. In some non-limiting embodiments of the present technology, the communication network 114 can be implemented as the Internet. In other embodiments of the present technology, the communication network 114 can be implemented differently, such as any wide-area communication network, local-area communication network, a private communication network and the like.

How the communication link 112 is implemented is not particularly limited and will depend on how the electronic device 102 is implemented. Recalling that the electronic device 102 is implemented, in this example, as a laptop, the communication link 112 can be either wireless (such as the Wireless Fidelity, or WiFi® for short, Bluetooth® or the like) or wired (such as an Ethernet based connection).

It should be expressly understood that implementations for the electronic device 102, the communication link 112 and the communication network 114 are provided for illustration purposes only. As such, those skilled in the art will easily appreciate other specific implementational details for the electronic device 102, the communication link 112 and the communication network 114. As such, by no means, examples provided herein above are meant to limit the scope of the present technology.

Also coupled to the communication network is a webmail server 116. The webmail server 116 can be implemented as a conventional computer server. In an example of an embodiment of the present technology, the webmail server 116 can be implemented as a Dell™ PowerEdge™ Server running the Microsoft™ Windows Server™ operating system. Needless to say, the webmail server 116 can be implemented in any other suitable hardware and/or software and/or firmware or a combination thereof. In the depicted non-limiting embodiment of present technology, the webmail server 116 is a single server. In alternative non-limiting embodiments of the present technology, the functionality of the webmail server 116 may be distributed and may be implemented via multiple servers.

The implementation of the webmail server 116 is well known. However, briefly speaking, the webmail server 116 comprises a communication interface (not depicted) structured and configured to communicate with various entities (such as the electronic device 102, for example and other devices potentially coupled to the communication network 114) via the communication network 114. The webmail server 116 further comprises at least one computer processor (not depicted) operationally connected with the communication interface and structured and configured to execute various processes to be described herein.

In some embodiments, the webmail server 116 can be operated by the same entity that has provided the afore-described e-mail application 104. In alternative embodiments, the webmail server 116 can be operated by an entity different from the one who has provided the afore-mentioned e-mail application 104.

The webmail server 116 can be implemented via several clusters of servers: e-mail delivery server cluster 117 and e-mail management server cluster 119. The e-mail delivery server cluster 117 acts as a mail transfer agent and transfers e-mail messages to and from the senders of e-mail messages and recipients of e-mail messages (such as the user associated with the electronic device 102.

To that end, the e-mail delivery server cluster 117 has access to an e-mail database 118. Even though the e-mail database 118 is depicted as coupled to the e-mail delivery server cluster 117 via the webmail server 116 using a dedicated communication link (not numbered), in alternative embodiments, the webmail server 116 can be coupled to the e-mail database 118 and/or the e-mail delivery server cluster 117 using the communication network 114. In yet additional embodiments of the present technology, the functionality of the e-mail database 118 can be incorporated into the functionality of the webmail server 116. Alternatively, functionality of both the e-mail delivery server cluster 117 and the e-mail database 118 can be incorporated into the functionality of the webmail server 116.

The e-mail management server cluster 119 can execute e-mail message classification in respect of e-mail messages destined for e-mail message recipients associated with the webmail server 116 (i.e. those who subscribe to e-mail services with the webmail server 116). To that end the e-mail management server cluster 119 has access to a behavior database 120. Even though the e-mail management server cluster 119 is depicted as coupled to the behavior database 120 via the webmail server 116 using a dedicated communication link (not numbered), in alternative embodiments, the webmail server 116 can be coupled to the behavior database 120 and/or e-mail management server cluster 119 using the communication network 114. In yet additional embodiments of the present technology, the functionality of the behavior database 120 can be incorporated into the functionality of the e-mail management server cluster 119. In yet additional embodiments of the present technology, the functionality of the behavior database 120 and the functionality of the e-mail management server cluster 119 can be incorporated into the functionality of the webmail server 116. In yet additional embodiments, the behavior database 120 and the e-mail database 118 can be implemented in a single database (not depicted). In yet further embodiments, some or all of the e-mail delivery server cluster 117, the e-mail management server cluster 119, the behavior database 120 and the e-mail database 118 can be executed on a single computing apparatus, such as the webmail server 116.

To complete the general description of the functionality of the webmail server 116, the webmail server 116 is configured to implement all of the functions that the users of the webmail server 116 may require, such as managing e-mail messages; managing the users' mailboxes, folders and subfolders; managing the users' e-mail account settings, interaction between the electronic device 102 and the webmail server 116, etc. Since general operation of the webmail server 116 is known to those skilled in the art, it will not be described here at any additional length.

The e-mail delivery server cluster 117 is configured to maintain, within the e-mail database 118, pending e-mail messages destined for the user associated with the electronic device 102. It should be noted that to the extent that the user of the electronic 102 has a pending e-mail message destined for her (in a sense that the user accesses her e-mail interface 106 for the purposes of checking e-mail messages destined to her), the user can be thought of as an e-mail message recipient in the sense that she is the intended recipient of the pending e-mail message.

As is known to those of skill in the art, a typical e-mail message can be formatted for exchange over the Internet (as an example of the communication network 114) in the format defined in RFC 5322 (available at, for example, http://toolsietforg/html/rfc5322). In the Internet e-mail message format, the e-mail message consists of two basic sections: the header and the body. The header of the e-mail message is structured in various fields that contain information about the e-mail message. The body of the e-mail message contains the content of the e-mail message.

Typical header fields can include: (i) a “from” field identifying the sender of the e-mail message by Internet e-mail address and in most cases by name, (ii) a “to” field identifying the recipient(s) of the e-mail message by Internet e-mail address and optionally by name; (iii) a “cc” field identifying persons receiving a copy of the e-mail message by Internet e-mail address and optionally by name; (iv) a “bcc” field identifying persons receiving a blind copy of the e-mail message by Internet e-mail address and optionally by name; (v) a “subject” field typically providing a brief summary of the topic of the e-mail message; (vi) a “date” field identifying the date and time that the e-mail message was sent (typically in local time and Greenwich Mean Time); (vii) a “message-ID” field providing a unique character string in respect of the e-mail message.

The above list is only intended as a brief summary of e-mail header fields typically found in most e-mail messages. It is not a complete list of all possible e-mail header fields. Also, it is noted that embodiments of the present technology are not limited to e-mail messaged formatted according to the RFC 5322 and can be equally applied to e-mail messages formatted differently.

The aforementioned body of the e-mail message includes the message's content. The content is typically either in plain text or HyperText Markup Language (HTML) and is typically encoded using an encoding scheme such as ASCII or Unicode.

The e-mail database 118 is configured to maintain the e-mail messages pending for the user associated with the user of the electronic device 102 as well as an indication of some or all of the aforementioned message fields. In some embodiments, the e-mail database 118 can also maintain the following information about the pending e-mail messages: receipt date, read date, user ID, time zone of the e-mail recipient, action the user has taken in association with the e-mail message (if any), the type of electronic device on which such action was executed, platform of such electronic device and/or its operating system, sequential number of the e-mail message within the inbox, socio-demographic information about the user and the like.

The e-mail delivery server cluster 117 is configured to access the e-mail database 118 and to retrieve pending e-mail messages destined for the user of the electronic device 102, for example, based on at least the destination e-mail address associated with the user of the electronic device 102 by matching it to the destination addresses stored within the “To” field of the plurality of pending messages stored at the e-mail database 118.

The e-mail management server cluster 119 is further configured to maintain the behaviour database 120. Generally speaking, the behaviour database 120 maintains past behaviour pattern indicative of how a given user (such as the user of the electronic device 102) is likely to deal with a given pending e-mail message based on how the given user has dealt with at least one past e-mail message of a same category.

More specifically, the e-mail management server cluster 119 is configured to compile and maintain the past behaviour pattern associated with the given user, such as the user of the electronic device 102. To that end, the e-mail management server cluster 119 is configured to maintain a list of pre-set categories for potential e-mail messages. A sample list of pre-set categories may include: “personal correspondence”, “financial”, “advertising”, “spam”, “others” and the like. Needless to say, the examples provided herein are meant to be non-limiting and non-exhaustive and other categories (as well as number of pre-set categories) can be used.

In some embodiments, the list of pre-set categories can be pre-set and amended from time to time by an operator of the webmail server 116. In other embodiments, the list of pre-set categories can be pre-set and amended from time to time by can be set based on an analysis of a sample of e-mail messages and selecting the most frequent categories, analysis and selection being done by the operator of the webmail server 116. In yet further embodiments, the list of pre-set categories can be pre-set and amended from time to time based on an analysis of a sample of e-mail messages and selecting the most frequent categories, analysis and selection being done by the webmail server 116 based on machine learning techniques or other suitable routines. In yet additional embodiments, the user of the electronic device 102 can pre-set (and amend from time to time) the pre-set categories.

In some embodiments of the present technology, the e-mail management server cluster 119 is configured to determine a category associated with a pending e-mail message destined for the given user, such as the user associated with the electronic device 102. In some embodiments of the present technology, the e-mail management server cluster 119 determines category of e-mail message in the context of observing and determining past behaviour pattern. In other embodiments of the present technology, the e-mail management server cluster 119 determines category of e-mail message in the context of retrieving past behaviour pattern associated with e-mail messages of the same category to determine one or more likely actions that the user is likely to execute with the e-mail message destined to the user. In other embodiments of the present technology, the e-mail management server cluster 119 determines category of e-mail message in the context of updating past behaviour pattern associated with e-mail messages of the same category to update one or more likely actions that the user is likely to execute with the e-mail message destined to the user.

Generally speaking, the process of categorization of a given pending e-mail message can be described as follows. An e-mail is sent by an e-mail sender (via another webmail server associated with the e-mail sender, which can be the webmail server 116 in case the sender of the e-mail is also a subscriber to the services provided by the webmail server 116).

The e-mail message is received by the e-mail deliver server cluster 117. The mail delivery server cluster 117 processes the incoming e-mail message. In some embodiments, some pre-processing determinations can be made by the e-mail delivery server cluster 117 (for example, if the incoming e-mail message contains viruses, is a spam message and the like) and further processing may be terminated based on some outcomes of such pre-processing determinations.

The e-mail delivery server cluster 117 then passes the incoming e-mail message to the e-mail management server cluster 119. The e-mail management server cluster 119 proceeds to make a determination of the e-mail message category, based on at least one attribute of the incoming e-mail message. In some embodiments, the at least one attribute is a sender type. In some embodiments, the at least one attribute is a message type. In other embodiments, the at least one attribute is a combination of the sender type and the message type.

In some embodiments, the sender type is determined based on the e-mail address of the sender (for example, whether an address comprises a name, such as joe.black@e-maildomain.com or a department title billing@serviceprovider.com). For example, for a given recipient can provision a list of e-mail addresses falling into different categories: family, friends, co-workers, etc. Alternatively, the e-mail management server cluster 119 can determine the various categories based on machine learning algorithms and the like.

In some embodiments, the message type is based on the analysis of the content of the message body of the incoming e-mail message. For example, based on the analysis of the body of the e-mail message, the e-mail management server cluster 119 can determine that the given incoming e-mail message falls under category “Notification” based on the following analysis:
The link “click here to unsubscribe” contains a linked URL in the form “unsubscribe” or “opt-out”.
The character string “message” is present in the body of the e-mail.
At least one of the following character strings: “personally”, “private”, “to you”, “received”, “for you”, “you have”, “unread”, “new” is found in the same sentence as the character string “message” in the e-mail.
The “Subject” header field does not contain character string “Re:” nor the character string “Fwd:”
The message does not have a message type “BOUNCE”.

An example of an e-mail categorization system and method are disclosed in a co-owned Russian utility model application entitled “METHOD OF AND SYSTEM FOR PROCESSING AN E-MAIL MESSAGE TO DETERMINE A CATEGORIZATION THEREOF” and bearing an application number 2013144681 and filed with the Russian Patent Office on Oct. 3, 2013, content of which is hereby incorporated by reference in its entirety in all those jurisdictions where such incorporation by reference is permitted by law. However, any other suitable method for assigning a category to an e-mail message can be used.

For the purposes of illustration of the present technology, we will make assumptions of three simplified incoming e-mail messages.

Scenario 1—sample E-Mail 1 is reproduced below:

Sample E-mail 1

| | |
|---|---|
| Subject: | Have a great vacation! |
| From: | mom@gmail.com |
| Date: | Wed, 7 May 2014 15:12:14 +0300 |
| To: | recipient@yandex.ru |

Have a great vacation.
Love,
Mom

Scenario 2—sample E-Mail 2 is reproduced below:

Sample E-mail 2

| | |
|---|---|
| Subject: | Your May bill |
| From: | accounting@internetprovider.com |
| Date: | Tues, 6 May 2014 11:12:14 +0300 |
| To: | recipient@yandex.ru |

Dear customer,
Your May bill is enclosed.
Kindest regards,
Internet Provider Billing Department
ATTACHMENT: bill

Scenario 3—sample E-Mail 3 is reproduced below:

Sample E-mail 3

| | |
|---|---|
| Subject: | Party this Saturday |
| From: | bob.smith@gmail.com |
| Date: | Wed, 7 May 2014 14:19:14 +0300 |
| To: | recipient@yandex.ru |

Hey there,
How about a party this Saturday?! Let's do it :-)
See ya!

In each of these scenarios, the e-mail management server cluster 119 determines the category of the incoming e-mail message: (i) for Scenario 1, it is determined that the category is “family”, (ii) for Scenario 2, it is determined that the category is “finances”, and (iii) for Scenario 3 it is determined that the category is “uncategorized”.

The e-mail management server cluster 119 then passes the incoming e-mail message back to the e-mail delivery server cluster 117, which then stores the incoming e-mail message (as well as an indication of the e-mail message category) in the e-mail database 118 in association with the e-mail message recipient (i.e. the user of the electronic device 102), based on the user's e-mail address as an example.

Now, let it be assumed that the user decided to check her e-mail messages and accesses the e-mail application 104 (let it be assumed that the e-mail application 104 is implemented as a webmail interface application). The webmail server 116 receives a request from the electronic device 102 for pending e-mail messages destined to the user of the electronic device 102. The e-mail delivery server cluster 117 retrieves the three e-mail messages mentioned in Scenario 1, Scenario 2 and Scenario 3 from the e-mail database 118 (as these messaged are pending for the e-mail message recipient—i.e. the user associated with the electronic device 102) and sends them to the electronic device 112.

The user takes certain actions with the three e-mail messages mentioned in Scenario 1, Scenario 2 and Scenario 3 and, according to embodiments of the present technology, the webmail server 116 receives an indication of such actions. In some embodiments, the indication of the actions is observed and transmitted by the e-mail application 104 itself. In other embodiments, the indication of the actions is observed and transmitted by another application installed on the electronic device 102.

Let it be assumed, that the user has taken the following actions with the three e-mail messages. E-mail message of Scenario 1: “open”, “reply”, “move to a folder”. E-mail message of Scenario 2: “open” and “forward”. E-mail message of Scenario 2: “open” and “delete”. It should be recalled that the e-mail messages within Scenario 1, Scenario 2 and Scenario 3 have been classified, respectively, as “family”, “financial” and “uncategorized”. The e-mail management server cluster 119 receives an indication of such actions and stores the following indication in the behavior database 120 in association with the user profile associated with the user of the electronic device 102 (based on the e-mail address or any other suitable identifier of the user of the electronic device 102): <family><reply><move>; <financial><forward>; <uncategorized><delete>.

Now, as the user of the electronic device 102 receives new incoming e-mail messages (and, hence, as the e-mail delivery server cluster 117 processes new incoming e-mail messages), the e-mail management server cluster 119: (i) categorizes the new incoming e-mail messages and (ii) receives indications of user interactions with the new incoming e-mail messages, when the user associated with electronic device 102 eventually retrieves and interacts with the incoming messages.

The e-mail management server cluster 119 then updates the information maintained within the behavior database 120, effectively creating and updating the past behaviour pattern associated with the user associated with the electronic device 102. Based on the above description how the e-mail management server cluster 119 populates the behaviour database 120, it should become apparent that the past behaviour pattern is indicative of the most likely action to be taken by the e-mail message recipient (i.e. the user of the electronic device 102) in respect to a particular pending e-mail message, based on its category and based on how the e-mail message recipient dealt with prior e-mail messages of the same category.

In some embodiments, the e-mail management server cluster 119 creates and/or updates the past behaviour pattern by analyzing the user interaction with a pre-set number of past e-mail messages of the same category and from the same e-mail message sender and selecting statistically most frequent action to be the most likely action. In other embodiments, the e-mail management server cluster 119 creates and/or updates the past behaviour pattern by analyzing the user interaction with a pre-set number of past e-mail messages of the same category irrespective of the identity of the e-mail message sender and selecting statistically most frequent action to be the most likely action. In some embodiments, where not enough prior actions have occurred, the e-mail management server cluster 119 can select a default action (such as “delete” or “reply” for example). The default action can be pre-set by the operator of the webmail server 116 or selected based on the most likely action associated with the e-mail message recipient based on all categories of e-mail messages.

In some embodiments, the e-mail management server cluster 119, when defining or updating the past behaviour pattern, only looks back at a pre-defined period of time, such as past day or past week or past month. The e-mail management server cluster 119 can execute a “force update” of the past behavior pattern after expiration of such pre-defined period of time. Within these embodiments, the past behaviour pattern may be based on a “fresh” information and, hence, be more responsive to the changes in user behaviour.

Now, when a new incoming message arrives destined for the e-mail message recipient being the user of the electronic device, the e-mail management server cluster 119 can retrieve, from the behaviour database 120, the past behaviour pattern associated with the user of the electronic device 102 and to determine the most likely action the user is to take with the new incoming message, based on its category. The process the webmail server 116 executes can be as follows. The new incoming e-mail message destined for the e-mail message recipient (i.e. the user of the electronic device 102) is received by the e-mail deliver server cluster 117. The e-mail delivery server cluster 117 processes the new incoming e-mail message. In some embodiments, some pre-processing determinations can be made by the e-mail delivery server cluster 117 (for example, if the new incoming e-mail message contains viruses, is a spam message and the like) and further processing may be terminated based on some outcomes of such pre-processing determinations.

The e-mail delivery server cluster 117 then passes the new incoming e-mail message to the e-mail management server cluster 119. The e-mail management server cluster 119 proceeds to make a determination of the e-mail message category, based on at least one attribute of the new incoming e-mail message, much akin to what was described above. In some embodiments, the at least one attribute is a sender type. In some embodiments, the at least one attribute is a message type. In other embodiments, the at least one attribute is a combination of the sender type and the message type.

The e-mail management server cluster 119 then access the behaviour database 120 to retrieve the past behavior pattern associated with the e-mail message recipient (i.e. the user of the electronic device 102), based on the so-defined category of the incoming e-mail message. In some embodiments of the present technology, the past behaviour pattern is retrieved based on the following request format: <email message category>. In other embodiments of the present technology, the past behaviour pattern is retrieved based on the following request format: <e-mail message sender>+<email message category>.

Based on the identified category of the new incoming e-mail message, the e-mail management server cluster 119 determines the most likely action associated with the category associated with the new incoming message. In some embodiments, the so-appreciated most likely action may include a first action and a second action.

For illustration purposes, let it be assumed that the new incoming message is as depicted in the following scenario.

Scenario 4—sample E-Mail 4 is reproduced below:

Sample E-mail 4

| | |
|---|---|
| Subject: | Hope you had a fantastic trip |
| From: | dad@gmail.com |
| Date: | Wed, 14May 2014 07:06:42 +0300 |
| To: | recipient@yandex.ru |

Hope the trip was fantastic. Send us pictures.
Dad

Based on the previously described routines, the e-mail management server cluster 119 determines that the category of the category of the new incoming e-mail message is “family”. The e-mail management server cluster 119 then, based on the category of the new incoming e-mail message, retrieves from the behaviour database 120 an indication of the past behaviour pattern associated with the e-mail message recipient (i.e. the user of the electronic device 102). In this example, the relevant portion of the retrieved past behaviour pattern includes: <family><reply><move>. The e-mail management server cluster 119 determines that for the new incoming e-mail message being of the “family” category, the first most likely action is “reply” and that the second most likely action is “move”. Now, it should be expressly understood that in other embodiments, the most likely action may comprise a single most likely action, while in others the most likely action may include more than two most likely actions (such as three, or four or even more).

In some embodiments of the present technology, responsive to the electronic device 102 requesting from the webmail server 116 the new pending e-mail messages destined for the user associated with the electronic device 102, the webmail server 116 sends to the electronic device 102 a trigger, which can be embodied in a command signal 140 (depicted in FIG. 1). In some embodiments, the command signal 140 can be embodied in an Extensible Markup Language (XML) signal. In other embodiments, the command signal 140 can be embodied in a JavaScript Object Notation (JSON) signal. Naturally, the command signal 140 can be embodied in any other suitable format and/or protocol.

The trigger (embodied in the command signal 140) can be instrumental in causing the electronic device 102 to display to the user, using the webmail application 104 a webmail page on the e-mail interface 106. Generally speaking, the webmail page includes: the pending e-mail message; and a first command button and a second command button in an order, the order of the first command button and the second command button having been selected based on the past behaviour pattern. It is noted that the webmail page can include and display a number of other elements (such as other new messages potentially present, previously received but unread e-mail messages, previously read e-mail messages, ads, control elements and the like).

In some embodiments of the present technology, the trigger causes the email application 104 to select the first command button and the second command button from a plurality of command buttons based on first most likely action and the second most likely action selected based on the past behaviour pattern. Within the example being presented herein, the classification cluster 119 selects the first command button and the second command button based on the first most likely action and the second most likely action from a plurality of possible actions. In the case of the E-mail message 4 (Scenario 4), the first command button would be a REPLY button, while the second command button would be a DELETE button. Needless to say, in those embodiments, where more than two most likely actions are determined, more than two action buttons can be selected.

In some embodiments of the present technology, the so selected first and second control buttons (or whatever the number of control buttons selected) are the only buttons displayed on the e-mail interface 106 in association with the e-mail message—i.e. when the user opens the given message (i.e. when the user actuates the e-mail application 104 into an e-mail mode or, in other words, the “message view” mode).

In some embodiments of the present technology, where more than one command button is identified (i.e. the first command button and the second command button are identified), the trigger is also instrumental in cause the electronic device 102 to place the first command button and the second command button in an order. The order can be selected from one of: (i) placing the second command button to the right of the first command button; (ii) placing the second command button to the left of the first command button; (iii) placing the second command button to the top of the first command button; and (iv) placing the second command button to the bottom of the first command button. Hence, in some embodiments of the present technology, it can be the that all of the first command button, the second command button and the order thereof are selected based on the past behaviour pattern.

In some embodiments of the present technology, the receiving of the request for pending e-mail messages for the e-mail message recipient is executed in response to the e-mail message recipient interacting with the webmail interface 106. For example, the user associated with the electronic device 102 may need to log into the e-mail service provided by the webmail server 116. This can be done based on a user name and password combination or any other suitable user credentials.

As such, in some embodiments of the present technology, the webmail server 116 can execute the steps of retrieving the pending e-mail message and retrieving of the indication of a past behaviour pattern based on user credentials (for example, based on the user name of the user associated with the electronic device 102).

In some embodiments of the present technology, the webmail server 116 further receives an indication of user interaction with the first command button and/or the second command button. Namely, the webmail server 116 can appreciate if the user has selected the first command button and/or the second command button. In some embodiments, the indication of the actions is observed and transmitted by the e-mail application 104 itself. In other embodiments, the indication of the actions is observed and transmitted by another application installed on the electronic device 102. Based on such indication, the e-mail management server cluster 119 can update the past behaviour pattern associated with the user. Naturally, the indication of the user interaction may include an indication that the user has executed an action other than those suggested by the first command button and/or the second command button.

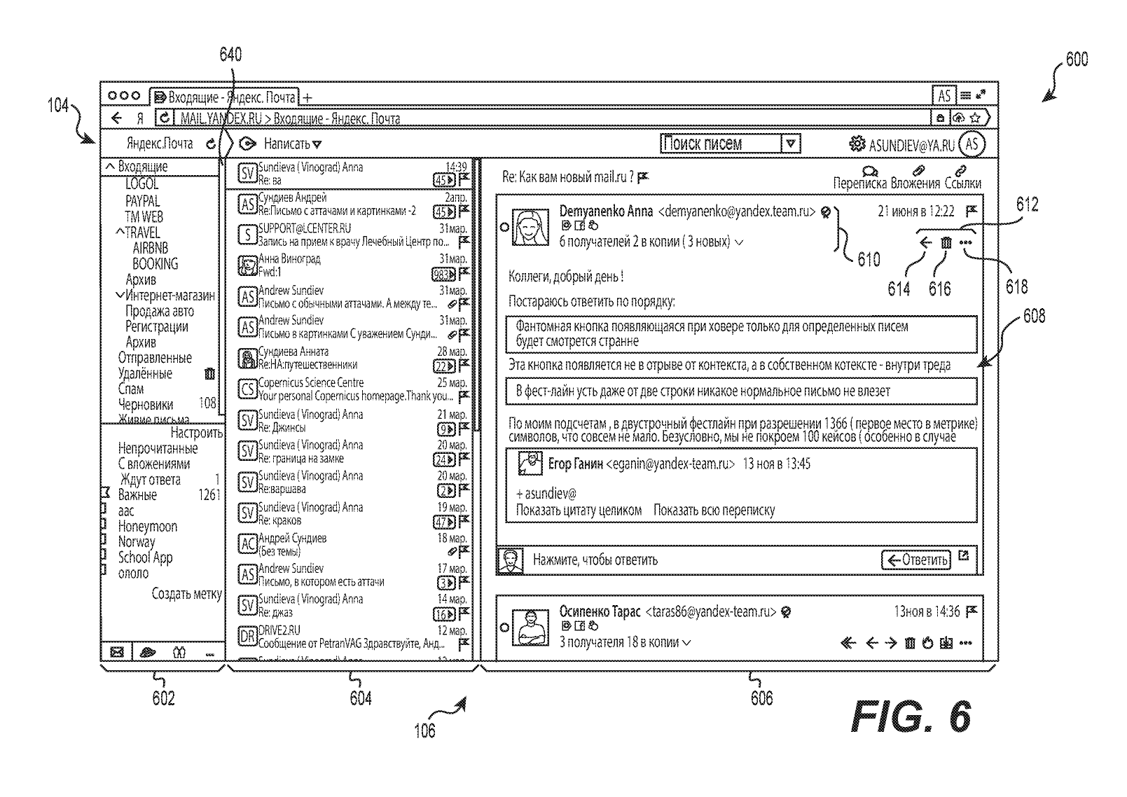

With reference to FIG. 6, there is depicted a screen shot 600, the screen shot 600 illustrating the e-mail application 104 implemented according to a non-limiting embodiment of the present technology. The e-mail application 104 is implemented as a webmail browser. The email application 104 includes the aforementioned e-mail interface 106. The e-mail interface 106 includes an inbox control panel 602, a list of e-mail messages 604 and an e-mail message reading pane 606. The inbox control panel 602 includes a list of available folders for organizing e-mail messages, creating new folders and the like. The list of e-mail messages 604 includes a list and a preview of e-mail messages destined to the user of the electronic device 102, including a new e-mail message 640 (which is currently being selected by the user and, therefore, is highlighted in the depiction of FIG. 6). The e-mail message reading pane 606 includes details of the currently selected e-mail message, i.e. the new e-mail message 640. The e-mail message reading pane 606 includes: a body of the e-mail field 608 and meta data information field 610, as is generally known in the art. According to embodiments of the present technology, the e-mail message reading pane 606 also includes a selected action buttons field 612. The selected action buttons field 612 comprises a first selected button 614 and a second selected button 616, the first selected button 614 and the second selected button 616 having been selected based on implementation of embodiments of the present technology. Within the illustrated embodiment, the first selected button 614 comprises a “REPLY” button and the second selected button 616 comprises a “DELETE” button.

In the depicted embodiment, the selected action buttons field 612 further comprises an additional actions button 618. The additional actions button 618 is for enabling the user of the electronic device 102 to execute another action with the e-mail message. It should be expressly understood, that the selected action buttons field 612 can have fewer or more action buttons than those depicted in FIG. 6. In other words, the selected action buttons field 612 can comprise at least one action button selected in accordance with embodiments of the present technology.

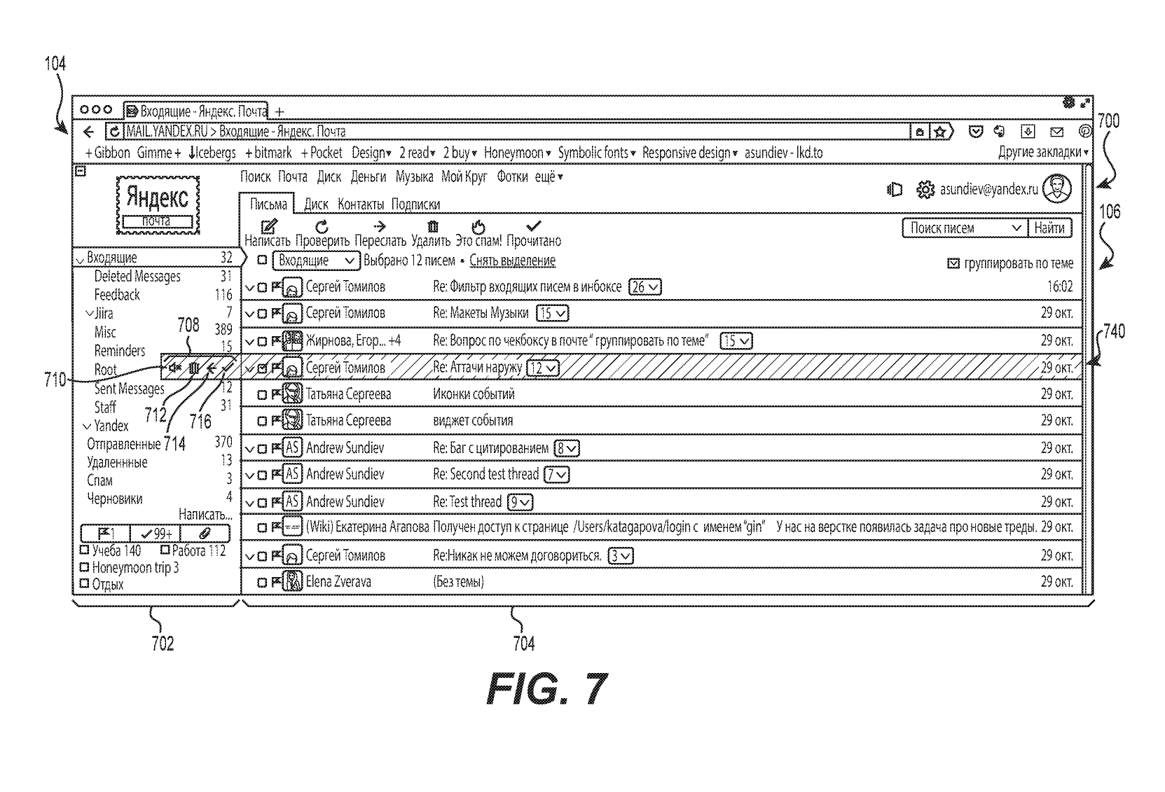

What was described with reverence to FIG. 6 can be thought of a “message view” of the e-mail application 104. One should understand that, additionally, embodiments of the present technology can also be applied to the “inbox view” of the e-mail application 104. An example of that is depicted with reference to FIG. 7, where there is depicted a screen shot 700, the screen shot 700 illustrating the e-mail application 104 implemented according to a non-limiting embodiment of the present technology and being in the “inbox view” mode.

The e-mail application 104 is implemented as a webmail browser. The email application 104 includes the aforementioned e-mail interface 106. The e-mail interface 106 includes an inbox control panel 702 and a list of e-mail messages 704. The inbox control panel 702 includes a list of available actions with the inbox, such as view inbox, view deleted messages, view sent messages, etc. The list of e-mail messages 604 includes a list of e-mail messages destined to the user of the electronic device 102, including a new e-mail message 740 (which is currently being selected by the user and, therefore, is highlighted in the depiction of FIG. 7). According to embodiments of the present technology, the e-mail interface 106 also includes a selected action buttons field 708. The selected action buttons field 708 comprises a first selected button 710, a second selected button 712, a third action button 714 and a fourth action button 716, all of the first selected button 710, the second selected button 712, the third action button 714 and the fourth action button 716 having been selected based on implementation of embodiments of the present technology. Within the illustrated embodiment, the first selected button 710 comprises a “PLAY” button, the second selected button 712 comprises a “DELETE” button, the third selected button 714 comprises a “REPLY” button and the fourth selected button 716 comprises a “MARK AS READ” button.

It should be expressly understood, that the selected action buttons field 708 can have fewer or more action buttons than those depicted in FIG. 7. In other words, the selected action buttons field 708 can comprise at least one action button selected in accordance with embodiments of the present technology. It is also noted that the selected action buttons field 708 can appear when the user hovers a mouse over the new message 740. Alternatively, the selected action buttons field 708 can appear as soon as the user selects the new message 740 to make it “active”. In case of the electronic device 102 having a touch-sensitive screen, the selected action buttons field 708 can appear when the user executes an action with the touch-sensitive screen of the electronic device 102 (such as a tap, a swipe and the like).

In other implementations of the present technology, that are particularly suitable but are not limited to those scenarios where the electronic device 102 is implemented as a smartphone or a tablet (or any other device that incorporates a touch-sensitive screen), the trigger embodied in the command signal 140 is instrumental to cause the electronic device 102 to be operable for: (i) displaying to the user, using the webmail application 104 a webmail page on the e-mail interface 106, the webmail page including the pending e-mail message; (ii) receiving an indication of a user-interaction with the touch-screen display in association with the e-mail message displayed; and (iii) displaying to the e-mail message recipient on the touch-sensitive screen an indication of an action to be executed with the e-mail message, the action based on the past behaviour pattern.

In some embodiments, the e-mail management server cluster 119 determines the action by selection the action from a plurality of pre-set actions based on the past behavior pattern. Continuing with the example being presented herein, the e-mail management server cluster 119 can select a first action as being REPLY and a second action as being DELETE. As such, the command signal 140 can cause the electronic device, responsive for example, to a swipe rather than display standard actions of MORE and TRASH, to display an indication of the first action REPLY and an indication of the second action TRASH. The command signal 140 can cause the electronic device, responsive for example, to a swipe rather than display standard actions of MORE and TRASH, to display an indication of the first action REPLY and an indication of the second action TRASH, as well as the general MORE option.

Even though the above examples use the user-interaction with the touch-screen display being a swipe, it does not need to be so. In other embodiments, the user-interaction with the touch-screen display can include one or more of: a tap; a single finger swipe; a double finger swipe; a virtual button actuation; a physical button actuation and the like. Furthermore, embodiments of the present technology, can assign various user-specific actions to different user-interactions with the touch-screen display, based on the prior behaviour pattern associated with the user of the electronic device 102.

In some embodiments of the present technology, the control signal 140 is further configured to cause the e-mail application 104 to organize the indication of the first action and the second action in an order. In some implementations, the order is based on the past behaviour pattern. For example, if the past behaviour pattern is indicative that the action REPLY has more weight (i.e. is more likely to occur), it may be places to the left of the action DELETE, which has a lower weight (and is, therefore, is less likely to occur than that REPLY action).

It should be noted that even though embodiments of the present technology have been described with the past behaviour pattern being stored at the behaviour database 120 located at the webmail server 116, in alternative embodiments, the indication of the past behaviour pattern can be stored locally at the electronic device 102 and accessible by the e-mail application 104. For example, the past behaviour pattern can be analyzed at the webmail server 116 and, from time to time, transmitted to and stored at the electronic device 102. Alternatively, the past behaviour pattern can be analyzed and stored at the electronic device 102.

Needless to say that in response to the user selecting the action proposed by the e-mail application 104, the e-mail application 104 can execute the action so selected by the user. It is also possible that the e-mail application 104 can execute the action without receiving a positive confirmation from the user or, in other words, execute the action automatically.

In some embodiments of the present technology, the webmail server 116 further receives an indication of user interaction with the indication of the first action and/or indication of the second action. Namely, the webmail server 116 can appreciate if the user has selected to execute the first action and/or the second action. In some embodiments, the indication of the actions is observed and transmitted by the e-mail application 104 itself. In other embodiments, the indication of the actions is observed and transmitted by another application installed on the electronic device 102. Based on such indication, the e-mail management server cluster 119 can update the past behaviour pattern associated with the user.

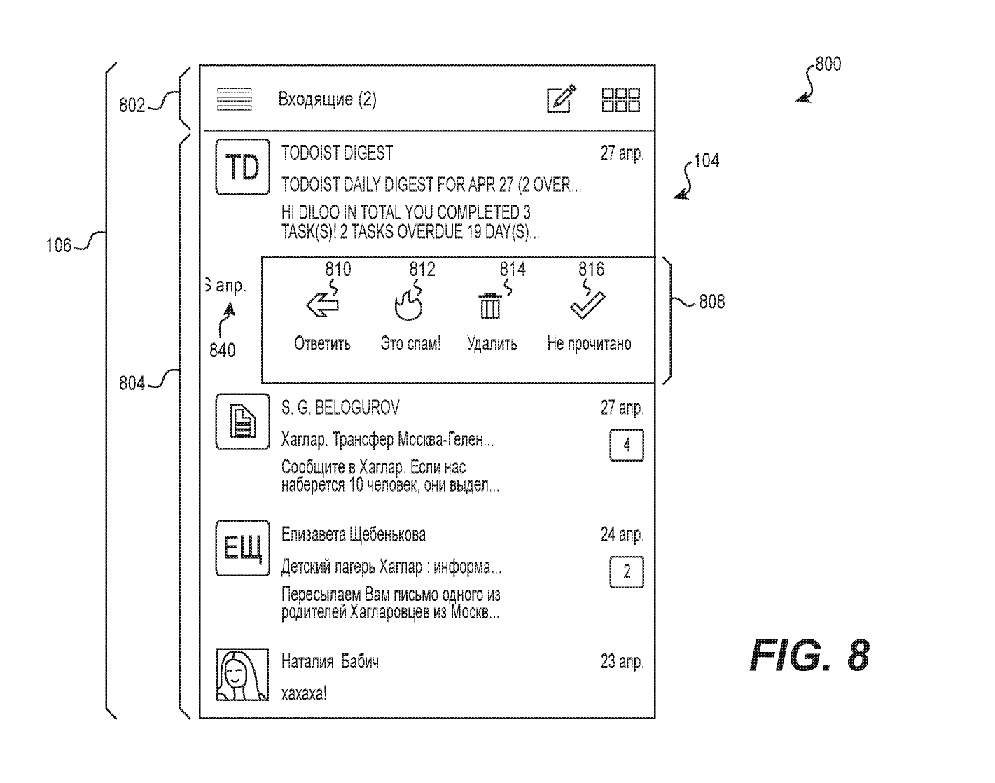

With reference to FIG. 8, there is depicted a screen shot 800, the screen shot 800 illustrating the e-mail application 104 implemented according to a non-limiting embodiment of the present technology on the electronic device 102 being implemented as smartphone. The e-mail application 104 is implemented as an e-mail application executed on the electronic device 102.

The email application 104 includes the aforementioned e-mail interface 106. The e-mail interface 106 includes an inbox control panel 802 and a list of e-mail messages 804. The inbox control panel 802 includes a list of available actions with the inbox, such as view inbox, compose a message, change view, etc.

The list of e-mail messages 804 includes a list of e-mail messages destined to the user of the electronic device 102, including a new e-mail message 840. Within the depiction of FIG. 8, the new e-mail message 840 is only partially visible (only a portion saying “anp”, which is the Russian version of “Apr” is visible in FIG. 8, as the user of the electronic device 102 has performed an action with the touch-sensitive screen of the electronic device 102 (such as a swipe or the like).

According to embodiments of the present technology, in response to the user interaction, the e-mail interface 106 also includes a selected action field 808. The selected action field 808 comprises an indication of a first action 810, an indication of a second action 812, an indication of a third action 814 and an indication of a fourth action 718, all of the indication of the first action 810, the indication of the second action 812, the indication of the third action 814 and the indication of the fourth action 718, having been selected based on implementation of embodiments of the present technology.

Within the illustrated embodiment, the indication of the first action 810 comprises a “REPLY” button, the indication of the second action 812 comprises a “THIS IS SPAM” button, the indication of the third action 814 comprises a “DELETE” button and the indication of the fourth action 718 comprises a “MARK AS READ” button.

It should be expressly understood, that the selected action field 808 can have fewer or more action buttons than those depicted in FIG. 8. In other words, the selected action field 808 can comprise at least one action button selected in accordance with embodiments of the present technology.

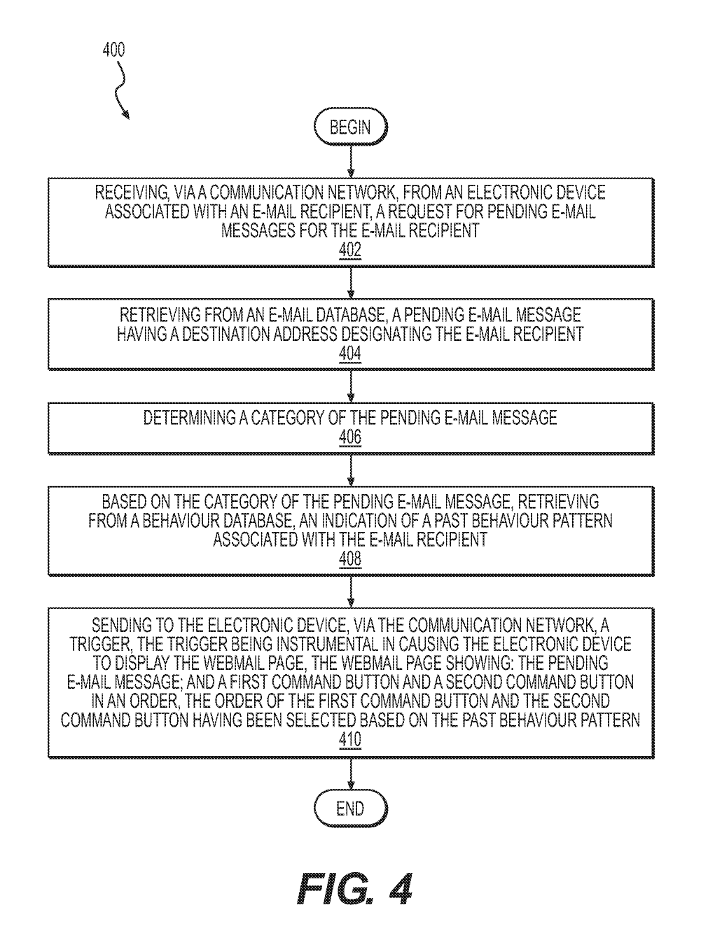

Given the architecture described with reference to FIG. 1 and examples provided herein above, it is possible to execute a method for displaying an e-mail message on a webmail page. The method can be conveniently executed at the webmail server 116. With reference to FIG. 4, there is depicted a block diagram showing steps of a method 400, the method 400 being executed according to non-limiting embodiments of the present technology.

Step 402—Receiving, Via a Communication Network, from an Electronic Device Associated with an E-Mail Recipient, a Request for Pending E-Mail Messages for the E-Mail Recipient

The method 400 starts at step 402, where the webmail server 116 receives, via the communication network 114, from the electronic device 102 associated with an e-mail recipient, a request for pending e-mail messages for the e-mail recipient.

In some implementations of the method 400, the step of receiving the request for pending e-mail messages for the e-mail message recipient is executed in response to the e-mail message recipient interacting with the webmail interface 106. As has been described above, the interacting between the user can be executed as the user authenticating in the webmail interface 106 using user credentials.

The method 400 then proceeds to step 404.

Step 404—Retrieving from an E-Mail Database, a Pending E-Mail Message Having a Destination Address Designating the E-Mail Recipient

Next, at step 404, the webmail server 116 Step 404 retrieves from the e-mail database 118, a pending e-mail message having a destination address designating the e-mail recipient.

In some implementation of the method, the step of retrieving the pending e-mail message is executed at least partially based on user credentials.

The method 400 then proceeds to step 406.

Step 406—Determining a Category of the Pending E-Mail Message

Next, at step 406, the webmail server 116 determines a category of the pending e-mail message, as has been described herein above.

In some implementations of the method 400, the step of determining the category of the pending e-mail message comprises selecting the category from a plurality of pre-set categories based on at least one of a sender of the pending e-mail message and application of a categorization rule (i.e. one or more of the routines described above).

The method 400 then proceeds to step 408.

Step 408—Based on the Category of the Pending E-Mail Message, Retrieving from a Behaviour Database an Indication of a Past Behaviour Pattern Associated with the E-Mail Recipient

Next, at step 408, the webmail server 116, based on the category of the pending e-mail message, retrieves from the behaviour database 120 an indication of a past behaviour pattern associated with the e-mail recipient.

In some implementations of the method 400, prior to the step of receiving, the method 400 further includes storing in the behaviour database 120 the indication of the past behaviour pattern associated with the e-mail recipient, the past behaviour pattern based on the actions taken by the e-mail message recipient with at least one past e-mail message belonging to the category.

In some implementations of the method 400, the step of storing comprises storing the past behaviour pattern in association with a user profile of the e-mail recipient.

In some implementation of the method 400, the step of retrieving the indication of a past behaviour pattern are executed at least partially based on user credentials.

The method 400 then proceeds to step 410.

Step 410—Sending to the Electronic Device, Via the Communication Network, a Trigger, the Trigger Being Instrumental in Causing the Electronic Device to Display the Webmail Page, the Webmail Page Showing: The Pending E-Mail Message; and a First Command Button and a Second Command Button in an Order, the Order of the First Command Button and the Second Command Button Having been Selected Based on the Past Behaviour Pattern

Next, at step 410, the webmail server 116 sends to the electronic device 102, via the communication network 114, a trigger, the trigger being instrumental in causing the electronic device to display the webmail page, the webmail page showing: the pending e-mail message; and a first command button and a second command button in an order, the order of the first command button and the second command button having been selected based on the past behaviour pattern.

In some implementations of the method 400, the step 410 further comprises selecting (or causing the electronic device 102 to select) the first command button and the second command button from a plurality of command buttons based on the past behaviour pattern. In some implementations of the method 400, the first command button and the second command button are the only command buttons displayed to the user in association with the e-mail message.

In some implementations of the method 400, the trigger is further instrumental in causing the electronic device 102 to display a third command button, the third command button also organized in the order with the first command button and the second command button, the first command button, the second command button and the third command button having been selected from a plurality of command buttons based on the past behaviour pattern.

In some implementations of the method 400, the first command button, the second command button and the third command button are the only command buttons displayed to the user in association with the e-mail message.

In some implementations of the method 400, the past behaviour pattern is indicative of the most likely action to be taken by the e-mail message recipient in association with the pending e-mail message and the first command button is associated with the most likely action and the order comprises placing the first command button first.

In some implementations of the method 400, the past behaviour pattern is indicative of a second most likely action to be taken by the e-mail message recipient in association with the pending e-mail message and the second command button is associated with the second most likely action and the order comprises placing the second command button after the first command button.

In some implementations of the method 400, placing second command button after the first command button comprises one of: placing the second command button to the right of the first command button; placing the second command button to the left of the first command button; placing the second command button to the top of the first command button; placing the second command button to the bottom of the first command button.

In some implementations of the method 400, the at least one past e-mail message comprises a first past action taken by the e-mail message recipient with a first past e-mail message and a second past action taken by the e-mail message recipient with a second past e-mail message, both the first past e-mail message and the second past e-mail message belonging to the same category, the method 400 further comprises, prior to the step of storing, determining the past behaviour pattern based on the first past action and the second past action.

In some implementations of the method 400, the step of determining of the category is executed using machine learning algorithms.

The method 400 then reverts to step 402 or terminates.

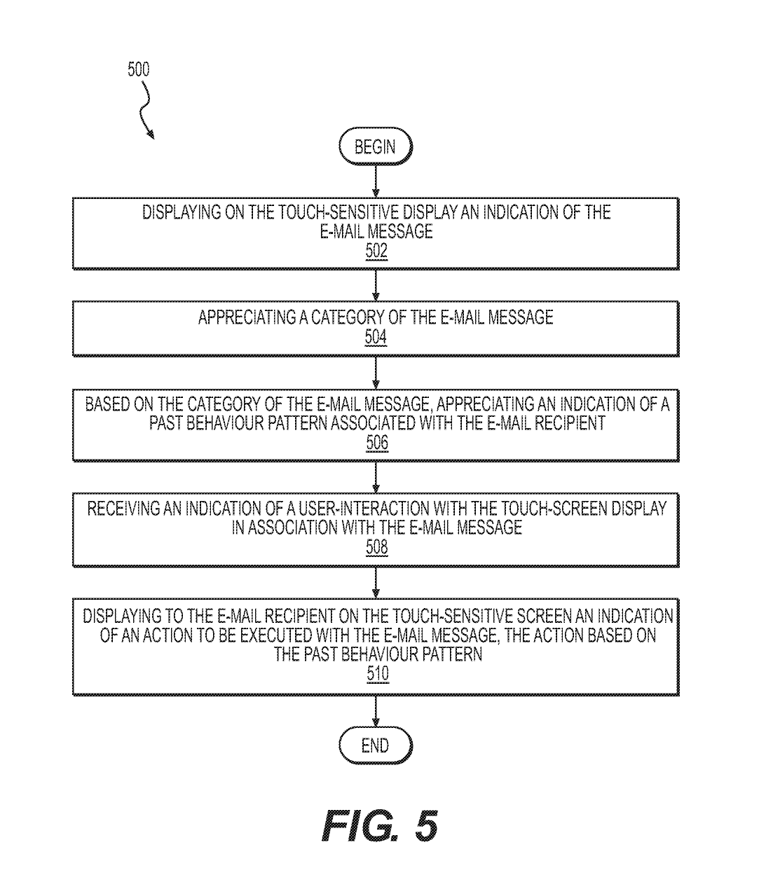

Given the architecture described with reference to FIG. 1 and examples provided herein above, it is possible to execute a method for displaying an e-mail message to an e-mail message recipient using the electronic device 102, the electronic device 102 having a touch-sensitive screen. The method can be executable at the electronic device 102. With reference to FIG. 5, there is depicted a block diagram showing steps of a method 500, the method 500 being executed according to non-limiting embodiments of the present technology.

Step 502—Displaying on the Touch-Sensitive Screen an Indication of the E-Mail Message

The method 500 starts at step 502, where the electronic device 102 displays on the touch-sensitive screen an indication of the e-mail message.

The method 500 then proceeds to step 504.

Step 504—Appreciating a Category of the E-Mail Message

Next, at step 504, the electronic device 102 appreciates a category of the e-mail message.

In some implementations of the method 500, the step 504 comprises determining the category of the e-mail message at the electronic device 102. In other implementations, the step 504 comprises receiving an indication of the category of the e-mail message from the webmail server 116.

In some implementations of the method 500, the step of appreciating the category of the e-mail message comprises selecting the category from a plurality of pre-set categories based on at least one of a sender of the e-mail message and application of a categorization rule (i.e. one of the routines described above).

The method 500 then proceeds to step 506.

Step 506—Based on the Category of the E-Mail Message, Appreciating an Indication of a Past Behaviour Pattern Associated with the E-Mail Recipient

Next, at step 506, the electronic device 102, appreciates a category of the e-mail message.

In some implementations of the method 500, the step 506 includes retrieving the indication of the past behaviour pattern from a local memory. In other implementations, the step 506 includes receiving the indication of the past behavior pattern from the webmail server 116.

In some implementations of the method 500, the past behaviour pattern is indicative of the most likely action the e-mail message recipient is to execute with the e-mail message based on e-mail message recipient actions with prior e-mail message of the same category. Therefore, in some implementations of the method 500, the indication of the action comprises the most likely action.

The method 500 then proceeds to step 508.

Step 508—Receiving an Indication of a User-Interaction with the Touch-Screen Display in Association with the E-Mail Message

Next, at step 508, the electronic device 102 receives an indication of a user-interaction with the touch-screen display in association with the e-mail message.

In some implementations of the method 500, the user-interaction with the touch-screen display comprises one of: a tap; a single finger swipe; a double finger swipe; a virtual button actuation; a physical button actuation.

The method 500 then proceeds to step 510.

Step 510—Displaying to the E-Mail Message Recipient on the Touch-Sensitive Screen an Indication of an Action to be Executed with the E-Mail Message, the Action Based in the Past Behaviour Pattern

Next, at step 510, the electronic device 102 displays to the e-mail message recipient on the touch-sensitive screen an indication of an action to be executed with the e-mail message, the action based of the past behaviour pattern.

In some implementations of the method 500, step 510 further comprises determining the action by selection the action from a plurality of pre-set actions based on the past behavior pattern.

In some implementations of the method 500, the step of displaying to the e-mail message recipient on the touch-sensitive screen an indication of an action to be executed with the e-mail message comprises displaying a first indication of a first action and an indication of a second action in an order.

In some implementations of the method 500, both the first action and the second action are based on the past behaviour pattern. In some implementations of the method 500, the order is also based on the past behaviour pattern.

In some implementations of the method 500, the method 500 further comprises executing the action with the e-mail message. In some implementations of the method 500, the step of executing is executed in response to receiving a positive confirmation from the e-mail recipient. In some implementations of the method 500, the method 500 further comprises not executing the action in response to receiving a negative confirmation from the e-mail recipient.

In some implementations of the method 500, the step of receiving the positive confirmation is executed in response to the e-mail message recipient executing an action with the indication of the action. In some implementations, the actions comprises one of: tapping; double tapping; swiping.

In some implementations of the method 500, the method 500 further comprises updating the past behaviour pattern based on one of positive confirmation and the negative confirmation from the e-mail recipient.

The method 500 then returns to execution of step 502 or terminates.

Even though the above methods have been described as recommending a command button or an action based on the category of the e-mail message and/or the category of the e-mail message and the e-mail message sender, the suggested command button and/or action can further depend on one or more of: (i) type of the electronic device 102 being used to check e-mails, (ii) time of day (such as business hours vs. non-business hours), (iii) a number of other unread e-mail messages in the inbox and the like.

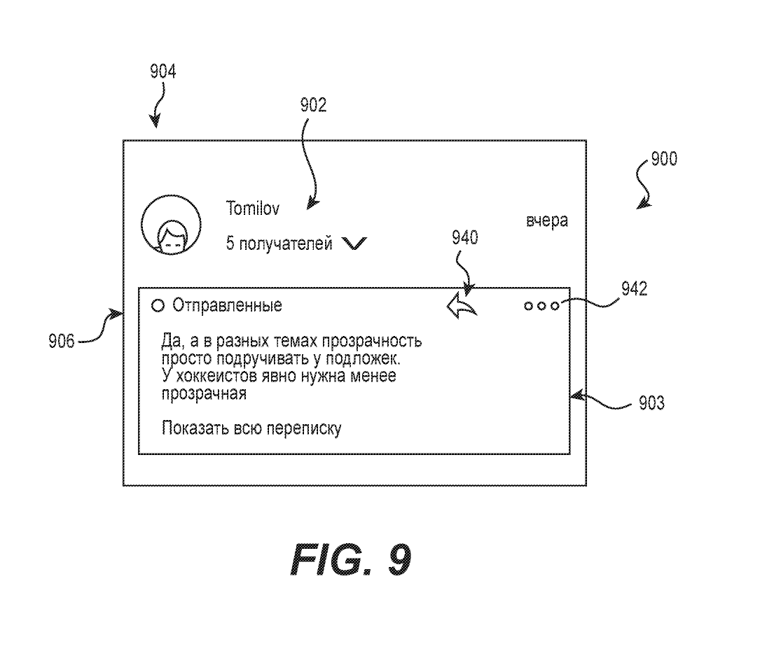

It should be noted that even though the above examples have used examples of an e-mail message, embodiments of the present technology are not necessarily limited to e-mail messages. As such, embodiments of the present technology can be adapted for use with other types of electronic messages, such as but not limited to: short text messages, instant text message, iPhone messages, For example, with reference to FIG. 9, there is depicted a screen shot 900, the screen shot 900 illustrating an embodiment of a chat application 904 implemented according to a non-limiting embodiment of the present technology on the electronic device 102 being implemented as smartphone. The chat application 904 can be thought of as a version of the e-mail application 104.

The chat application 904 includes a chat interface 906. The chat interface 906 includes a chat control panel 902 and a chat box 603. The chat control panel 902 includes a list of available actions with the chat, such as view chats, view list of chat participants, an indication of the time of the chat, etc.

The chat box 603 includes one or more chat messages. According to embodiments of the present technology, the chat box 603 includes a selected action button 940, the selected action button 940 having been selected in accordance with embodiments of the present technology. Within the illustrated embodiment, the selected action button 940 comprises a “REPLY” button. The chat box 603 also includes an additional action button 942, the additional action button 942.

It should be expressly understood, that there can be more than one instance of the selected action button 940, much akin for example, to the depiction of the embodiment of FIG. 7.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for displaying an electronic message to an electronic message recipient using an electronic device, the electronic device having a touch-sensitive screen, the method executable at the electronic device, the method comprising:
displaying on the touch-sensitive screen an indication of the electronic message;
acquiring a category of the electronic message;
based on the category of the electronic message, acquiring an indication of a past behaviour pattern associated with the electronic message recipient;
receiving an indication of a user-interaction with the touch-screen display in association with the electronic message;
displaying to the electronic message recipient on the touch-sensitive screen a command button associated with an action to be executed with the electronic message, the action based on the past behaviour pattern;
in response to the user actuating the command button, executing the action with the electronic message.

2. The method of claim 1, wherein the past behaviour pattern is indicative of the most likely action the electronic message recipient is to execute with the electronic message based on electronic message recipient actions with a prior electronic message of the same category.

3. The method of claim 2, wherein the action comprises the most likely action.

4. The method of claim 1, further comprising determining the action by selecting the action from a plurality of pre-set actions based on the past behavior pattern.

5. The method of claim 1, wherein the user-interaction with the touch-screen display comprises one of:
a tap;
a single finger swipe;
a double finger swipe;
a virtual button actuation;
a physical button actuation.

6. The method of claim 1, wherein the displaying to the electronic message recipient on the touch-sensitive screen a command button associated with an action to be executed with the electronic message comprises displaying a first command button associated with a first action and a second command button associated with a second action in an order.

7. The method of claim 6, wherein both the first action and the second action are based on the past behaviour pattern.

8. The method of claim 6, wherein the order is based on the past behaviour pattern.

9. The method of claim 6, wherein all of the first action, the second action and the order are based on the past behaviour pattern.

10. The method of claim 1, wherein the acquiring the category of the electronic message comprises determining the category of the electronic message at the electronic device.

11. The method of claim 1, wherein the acquiring the category of the electronic message comprises receiving an indication of the category of the electronic message from an electronic message server.

12. The method of claim 1, wherein acquiring the indication of the past behaviour pattern comprises retrieving the indication of the past behaviour pattern from a local memory.

13. The method of claim 1, wherein acquiring the indication of the past behaviour pattern comprises receiving the indication of the past behaviour pattern from an electronic message server.

14. (canceled)

15. The method of claim 1, wherein the executing is executed in response to receiving a positive confirmation from the electronic message recipient.

16. The method of claim 15, further comprising not executing the action in response to receiving a negative confirmation from the electronic message recipient.

17. The method of claim 16, further comprising updating the past behaviour pattern based on one of the positive confirmation and the negative confirmation from the electronic message recipient.

18. The method of claim 15, wherein the receiving the positive confirmation is executed in response to the electronic message recipient executing an action with the command button.

19. The method of claim 18, wherein the action comprises one of:
tapping;
double tapping;
swiping.

20. The method of claim 1, wherein the acquiring the category of the electronic message comprises selecting the category from a plurality of pre-set categories based on at least one of a sender of the electronic message and application of a categorization rule.

21. An electronic device comprising:
a touch-sensitive screen for receiving a user input and providing a user output;
a network communication interface for two-way communication over a communication network; and
a processor coupled to the touch-sensitive screen and the network communication interface, the processor being configured to have access to computer readable commands which commands, when executed, cause the processor to execute an a-mail application, the commands being further operable to cause the processor to:
display on the touch-sensitive screen an indication of the electronic message;
acquire a category of the electronic message;
based on the category of the electronic message, acquire an indication of a past behaviour pattern associated with the electronic message recipient;
receive an indication of a user-interaction with the touch-screen display in association with the electronic message;
display to the electronic message recipient on the touch-sensitive screen a command button associated with an action to be executed with the electronic message, the action based on the past behaviour pattern;
in response to the user actuating the command button, execute the action with the electronic message.

22-40. (canceled)

41. A method for displaying an electronic message to an electronic message recipient using an electronic device, the electronic device having a touch-sensitive screen, the method executable at the electronic device, the method comprising:
displaying on the touch-sensitive screen an indication of the electronic message;
acquiring a category of the electronic message;
based on the category of the electronic message, appreciating an indication of a past behaviour pattern associated with the electronic message recipient;
receiving an indication of a user-interaction with the touch-screen display in association with the electronic message;
displaying to the electronic message recipient on the touch-sensitive screen a command button associated with an action to be executed with the electronic message, the action based on the past behaviour pattern;
in response to the user actuating the command button, executing the action with the electronic message.
